(19) United States
(12) Patent Application Publication
(10) Pub. No.: US 2026/0195456 A1
(43) Pub. Date: Jul. 9, 2026

(54) SOFTWARE IDENTITY AND INTEGRITY SECURING SYSTEM AND METHOD FOR A SOFTWARE IDENTITY ISSUANCE AGENT

(71) Applicant: Dell Products L.P., Round Rock, TX (US)

(72) Inventors: Eugene David Cho, Austin, TX (US); Mukund P. Khatri, Austin, TX (US); Alan White, Glasgow (GB); Dominique Prunier, Montreal (CA)

(73) Assignee: Dell Products L.P., Round Rock, TX (US)

(21) Appl. No.: 19/014,420

(22) Filed: Jan. 9, 2025

(51) Int. Cl. G06F 21/57; G06F 21/60; G06F 21/72

(52) U.S. Cl. CPC G06F 21/57; G06F 21/602; G06F 21/72; G06F 2221/033

(57) ABSTRACT

Systems and methods for a software identity and integrity securing system and method for a software identity issuance agent that provides a trust chain that may be established from a Hardware Root-of-Trust (HWRoT) to a SWIDIA agent. According to one embodiment, an Information Handling System (IHS) may include: a processor, a hardware device configured to function as a HWRoT, and a Software Identity Framework agent. The Software Identity Framework agent may be configured to communicate with the hardware device to establish a trust chain with the HWRoT, and using the trust chain, attest one or more applications configured on the IHS.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Cloud computing refers to a group of network elements providing services on demand, such as data storage and computing power, without directed active management by a user. Cloud computing relies on a sharing of resources to achieve coherence and economies of scale. Cloud computing can be provided as a service over the Internet, such as in the form of "Infrastructure as a Service" (IaaS), "Platform as a Service" (PaaS), and/or "Software as a Service" (SaaS). A Platform as a Service (PaaS) provider allows a consumer to deploy onto the PaaS cloud infrastructure consumer resources created using program language, libraries, services and tools supported by the PaaS provider. The consumer does not manage or control the underlying cloud infrastructure, including the networks, servers, operating systems, or storage, but has control over the deployed applications. Platform as a Service (PaaS) providers offer a computing platform, typically including an operating system, programming language execution environment, database, and web server, and the consumer, or user, develops and runs software on the cloud platform, rather than obtaining and maintaining the underlying hardware and software layers.

### SUMMARY

Systems and methods for a software identity and integrity securing system and method for a software identity issuance agent that provides a trust chain that may be established from a Hardware Root-of-Trust (HWRoT) to a SWIDIA agent. According to one embodiment, an Information Handling System (IHS) may include: a processor, a hardware device configured to function as a HWRoT, and a Software Identity Framework agent. The Software Identity Framework agent may be configured to communicate with the hardware device to establish a trust chain with the HWRoT, and using the trust chain, attest one or more applications configured on the IHS.

According to another embodiment, a software identity and integrity securing method includes the steps of communicating, using a Software Identity Framework agent, with a hardware device to establish a trust chain with a Hardware Root-of-Trust (HWRoT), and using the trust chain, attest one or more applications configured on an Information Handling System (IHS).

According to yet another embodiment, a non-transitory memory storage device with program instructions stored thereon that, upon execution by an Information Handling System (IHS), cause the IHS to communicate, using a Software Identity Framework agent, with the hardware device to establish a trust chain with a Hardware Root-of-Trust (HWRoT), and using the trust chain, attest one or more applications configured on the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 shows an example of an IHS that may be configured to implement a software identity and integrity securing system and method for a software identity issuance agent according to one embodiment of the present disclosure.

FIG. 2 illustrates an example software identity and integrity securing system showing how a trust chain may be established from a Hardware Root-of-Trust (HWRoT) to a Software Identity Issuance Agent (SWIDIA) according to one embodiment of the present disclosure.

FIG. 3 illustrates an example trust hierarchy establishment method that may be used to provide a software identity and integrity securing system and method for a software identity issuance agent according to one embodiment of the present disclosure.

FIG. 4 illustrates another example trust hierarchy establishment method that may be used to provide a software identity and integrity securing system and method for a software identity issuance agent according to one embodiment of the present disclosure.

FIG. 5 illustrates a trust progression table showing how the trust in the SWIDIA agent may evolve over time according to one embodiment of the present disclosure.

FIG. 6 illustrates an example software identity provisioning method showing how the software identity and integrity securing system may be used to initially provision a SWIDIA identity with a SWIDIA agent that has been installed on an IHS according to one embodiment of the present disclosure.

FIG. 7 illustrates an example software identity re-provisioning method showing how the software identity and integrity securing system may be used to re-provision a SWIDIA identity with an updated SWIDIA agent according to one embodiment of the present disclosure.

FIG. 8 illustrates an example software identity re-sealing method showing how the software identity and integrity securing system may be used to re-seal a SWIDIA identity when the SWIDIA agent is updated with new firmware according to one embodiment of the present disclosure.

FIG. 9 illustrates an example software identity usage method showing how the software identity and integrity securing system may be used in a trusted state according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

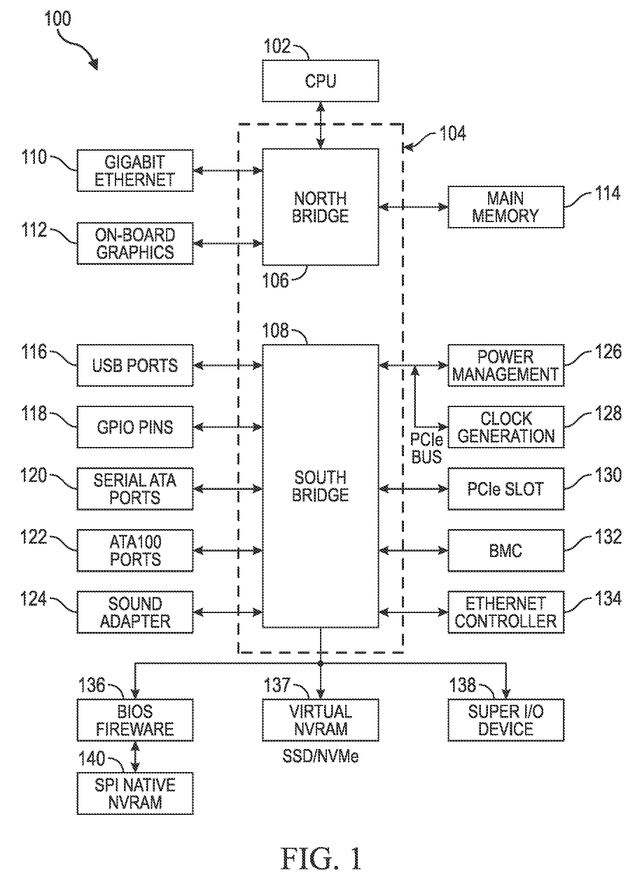

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Recently, cloud native workload authentication techniques have been developed to provide a security identity to each of multiple applications (e.g., workloads) running on an IHS. One example of such a workload authentication technique may include a Secure Production Identity Framework for Everyone (SPIFFE) protocol that may run a suitable agent, such as a SPIFFE runtime environment (SPIRE) on the IHS for attesting the workloads. Other workload authentication techniques may exist, such as OS for Crypto SWID, Linux OS (EL0-X) for UID/PID, and an external or local service for assigned unique software (e.g., APEX). These workload authentication techniques may provide a security identity (ID) to each of the workloads and enable an individual application to identify and cryptographically authenticate other applications that it needs to communicate with, such as SPIFFE Verifiable Identity Documents (SVIDs) as used with SPIFFE compliant techniques. Additionally, the SPIFFE SPIRE agent may provide a workload API for any workload (e.g., application) that wants to leverage it.

Nevertheless, current Software Identity Frameworks (e.g., SPIFFE), build multiple software identity trusts on top of a single software identity of the Software Identity Issuance Agent (SWIDIA), which can in some cases, be easily spoofed (e.g., a circular dependency, house of cards). Insufficient protection of the SWIDIA Identity can expose and/or compromise some, most, or all of the SWID’s issued or endorsed by that SWIDIA entity. As such, it would be beneficial to build in additional measures to protect the SWIDIA Identity. For example, a SWIDIA Identity should remain “unique-per-instance of hardware and unique-per-instance of software.” While a randomly generated key may meet this requirement, this may have certain security limitations (e.g., spoofing, untraceable provenence, etc.). Additionally, any solution should support factory and in-field installation and provisioning of the SWIDIA as well as provide support for native and/or non-native (e.g., third party) hardware. Compared to when running on Non-native hardware, solution should have enhanced security resiliency when running on native hardware and embedded systems, and should support software Integrity assurances up to the SWIDIA agent. As will be described in detail herein below, embodiments of the present disclosure provide a software identity and integrity securing system and method for a software identity issuance agent that provides a trust chain that may be established from a Hardware Root-of-Trust (HWRoT) to a SWIDIA agent.

FIG. 1 shows an example of an IHS 100 that may be configured to implement a software identity and integrity securing system and method for a software identity issuance agent according to one embodiment of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 126, Ethernet controller 134, and one or more general purpose input/output (GPIO) pins 120. Southbridge 108 may also provide a bus for interfacing peripheral card devices such as PCIe slot 132. In some embodiments, the bus may include a peripheral component interconnect (PCI) bus. Southbridge 108 may also provide baseboard management controller (BMC) 134 for use in managing the various components of the IHS 100. Power management circuitry 126 and clock generation circuitry 130 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 122 and/or an ATA100 adapter for providing one or more ATA100 ports 122. Serial ATA ports 122 and ATA100 ports 124 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 132, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 134 may include non-volatile memory having program instructions stored thereon that enable remote management of the IHS 100. For example, BMC 134 may enable a user to discover, configure, and manage the IHS 100, setup configuration options, resolve and administer hardware or software problems, etc. Additionally or alternatively, BMC 134 may include one or more firmware volumes, each volume having one or more firmware files used by the BIOS’ firmware interface to initialize and test components of the IHS 100.

As a non-limiting example of BMC 134, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

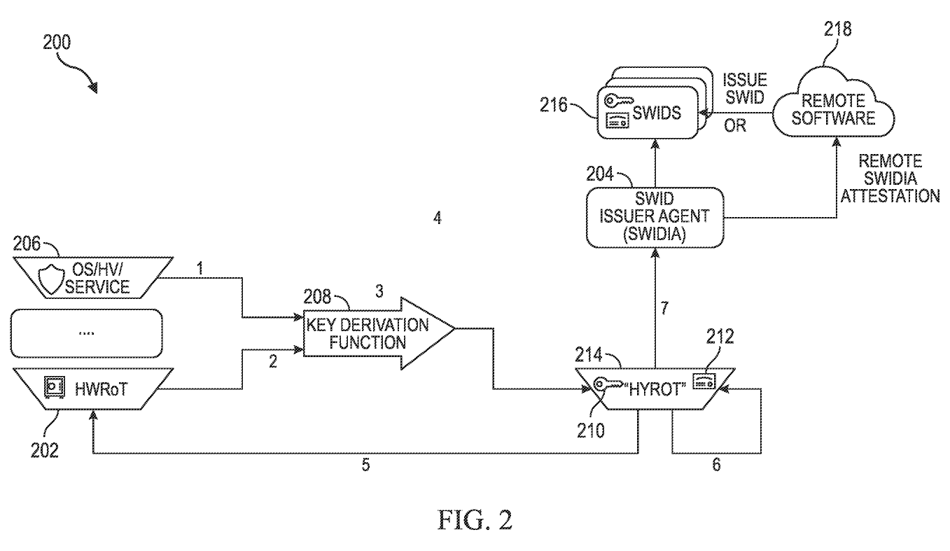

FIG. 2 illustrates an example software identity and integrity securing system showing how a trust chain 200 may be established from a HWRoT 202 to a SWIDIA agent 204 according to one embodiment of the present disclosure. The HWRoT 202 may be any type that generates a static ID Number (e.g., long-lived number), such as a silicon unique serial number. Examples of such devices may include a trusted platform module (TPM), an overall platform Root of Trust, a CPU Root of Trust, or even a Baseboard Management Controller (BMC) configured in the IHS 100. The SWIDIA agent 204 may be any type, such as a SPIFFE SPIRE agent, an OS for Crypto SWID, Linux OS (EL0-X) for UID/PID, and an external or local service for assigning unique software. The SWIDIA agent 204 generates, for each of multiple workloads (e.g., applications) on the IHS 100, an individual SWID 216 for each workload, such that when a particular workload is invoked or otherwise launched on the IHS 100, the SWIDIA agent 204 may communicate with an online SWIDIA service 218 to verify the authenticity of the workload.

The trust chain 200 includes an operating system (OS) / hypervisor (HV) service 206 that generates a unique id number for each SWID 216. The OS/HV service 206 may be, for example, a static ID Number (e.g., assigned serial number from control plane, metadata from a remote command or attestation procedure (i.e. periodic reissuance), boot time measurements (i.e. TPM, PCR, software integrity, etc.), history of software updates (e.g., software updates performed over time). When a unique id number is generated, it is combined with a key derivation function 208 to generate a key 210 and a certificate 212 that may be used by a hybrid root-of-trust (HyRoT) node 214, which is used to verify the authenticity of the SWIDIA 204. Thus as can be seen, the trust chain 200 may be used to provide for trust in the SWIDs 216 in a manner that extends from the HWRoT 202 to the SWIDIA 204 for ensuring its integrity.

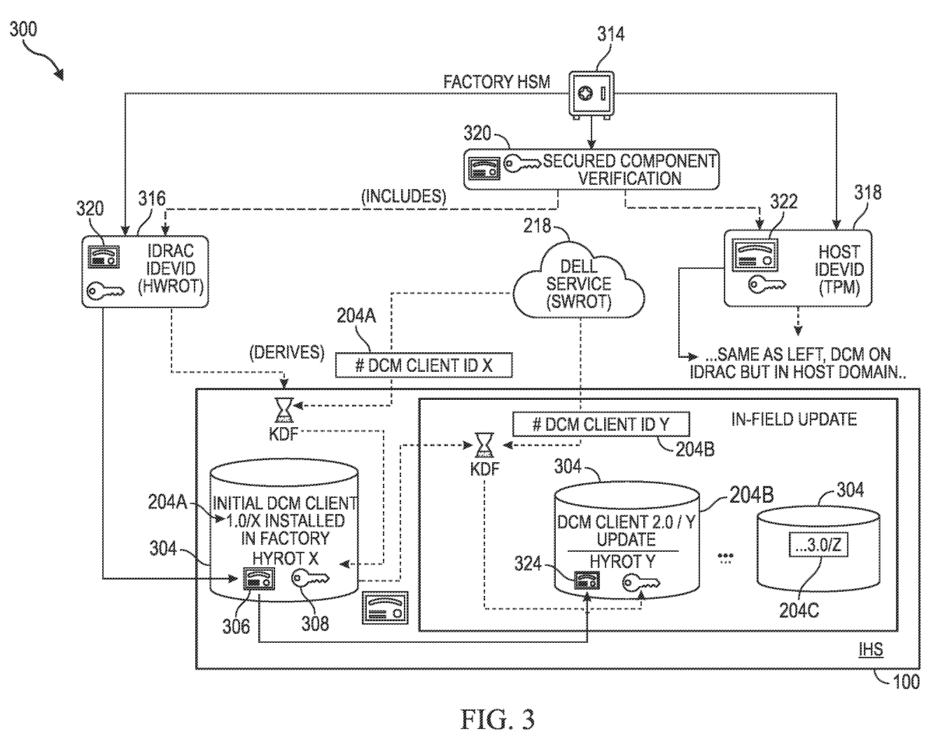

FIG. 3 illustrates an example trust hierarchy establishment method 300 that may be used to provide a software identity and integrity securing system and method for a software identity issuance agent according to one embodiment of the present disclosure. The trust hierarchy establishment method 300 involves an IHS 100 that is installed with an initial SWIDIA agent 204a on a storage unit 304 of an IHS 100 in the factory; that is, when the IHS 100 is manufactured or otherwise assembled into a working device for the first time. The SWIDIA agent 204a is shown as having a 1.0/X generic version label to indicate that it is the first version installed on the IHS 100. When installed, the trust hierarchy establishment method 300 generates a certificate 306 that is stored in a secured memory of the IHS 100, and a key 308 that is securely provided to an online SWIDIA service 218. Because the certificate 306 and key 308 are generated in the factory, its level of trust can be relatively high.

The trust hierarchy establishment method 300 may provide a chain of trust for the SWIDIA agent 204a that extends back to a factory hardware security module (HSM) 314 associated with the vendor of the IHS 100. The HSM 314 generally refers to a secure module that stores a certificate that is known only by the vendor of the IHS 100. The next link in the trust chain may include either a BMC HWRoT 316 or a host HWRoT identity 318 each having (e.g., unique-per-product certificates (SCV, IDevID, etc.) that may be signed by the HSM 314 to create the certificates 320 and 322 that are stored in the product. The BMC HWRoT 316 or host HWRoT identity 318 may, in turn, use certificate 320 or 322, respectively, to sign the certificate in the HyRoT 316 of the certificate 212. The HyRoT 316 may then verify the authenticity of the SWIDIA agent 204a by communicating with the SWIDIA service 218 in the cloud. Thus, a certificate trail may be provided that extends from the factory HSM 314 to the SWIDIA agent 204a, thus providing end-to-end software security.

In one embodiment, the trust hierarchy establishment method 300 may provide the certificate trail through a Secured Component Verification (SCV) identity 320 such that it may communicate with either of the BMC HWRoT 316 or host HWRoT identity 318 to verify their authenticity.

The method 300 may also provide for ongoing updates (e.g., firmware updates) that occur over the lifetime of the IHS 100. For example, when a second SWIDIA agent 204b is updated on the IHS 100, the certificate 306 associated with the first version (e.g., version 1.0/X) may be used to sign the certificate 324 associated with the second SWIDIA agent 204b (e.g., version 2.0/Y) to verify its authenticity. A similar process may be performed for other ensuing updates to the SWIDIA agent 204c (e.g., version 3.0/Z) on the IHS 100.

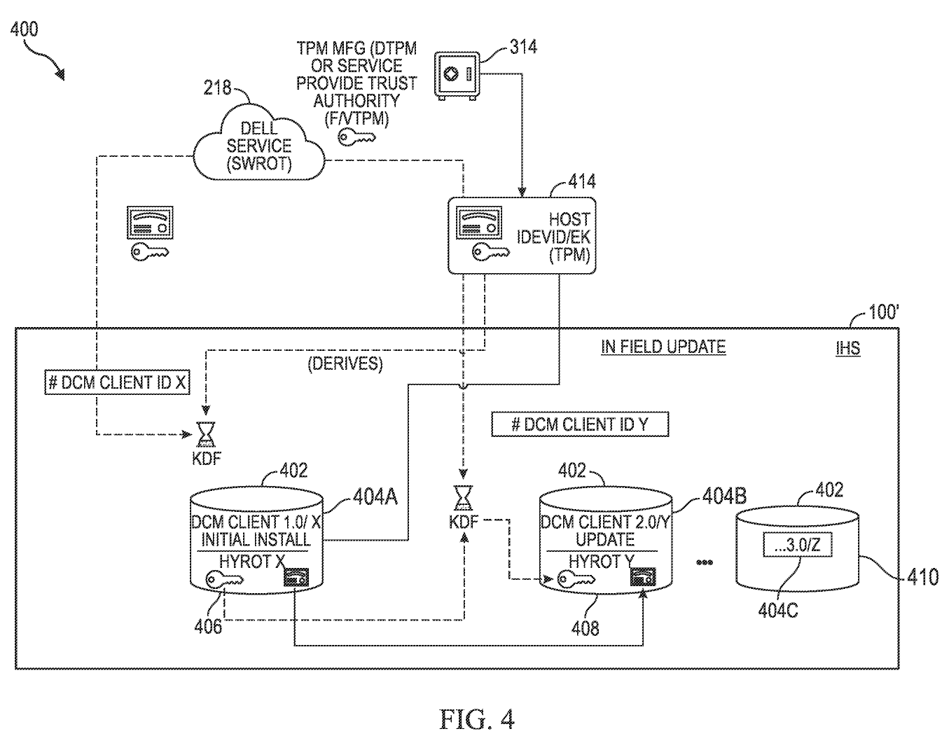

FIG. 4 illustrates another example trust hierarchy establishment method 400 that may be used to provide a software identity and integrity securing system and method for a software identity issuance agent according to one embodiment of the present disclosure. The trust hierarchy establishment method 400 involves an IHS 100’, which is provided by a third party vendor, and is installed with an initial SWIDIA agent 404a on a storage unit 402 of the IHS 100’ with an initial HyRoT 406. Later on, when ensuing SWIDIA agents 404b-c are installed, corresponding ensuing HyRoTs 408, 410 may be signed by their previously installed HyRoTs 406, 408 respectively as described above with reference to FIG. 3. The method 400 of FIG. 4 differs from the method 300 of FIG. 3 in that, because the IHS 100’ is provided by a third party vendor separate and distinct from the owner of the HSM 314, the chain of trust is extended through a TPM 414 (e.g., a discrete TPM (dTPM), a firmware TPM (fTPM), a virtual TPM (vTPM), etc.) between the HSM 314 and SWIDIA agents 404a-c. That is, because the owner of HSM 314 may have little or no control of how the initial SWIDIA agent 404a is installed on the IHS 100’, it may rely on the TPM 414 provided by the third party vendor to provide the chain of trust.

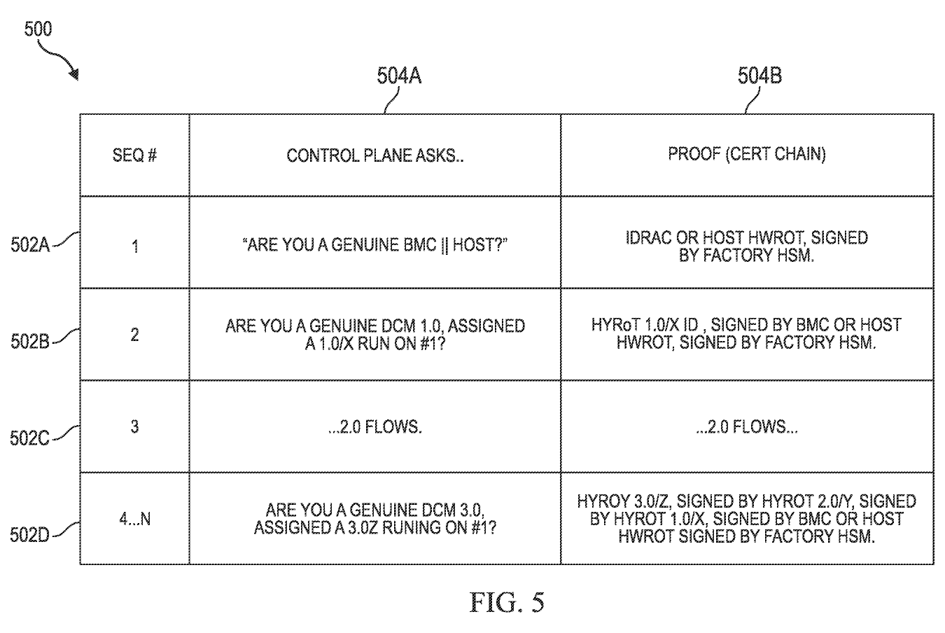

FIG. 5 illustrates a trust progression table 500 showing how the trust in the SWIDIA agent may evolve over time according to one embodiment of the present disclosure. The trust progression table 500 includes multiple rows 502a-d indicating how the chain of trust in the SWIDIA agent progresses over time. For example, row 1 is performed first, followed by row 2, and so on for as long as the SWIDIA agent is updated over time. The trust progression table 500 also includes a control plane column 504a and a proof of trust column 504b showing how proof of trust is obtained. The control plane generally refers to the platform that may be used to verify the trust in the SWIDIA agent, and may include, for example, the SWIDIA service 218.

Initially at row 1502a, the control plane may verify the trust in the hardware by signing the BMC 134 or HwRoT (e.g., TPM, platform root of trust, CPU root of trust, etc.) with the certificate of the factory HSM 314. Next at row 2 502b, the control plane may verify the trust in the SWIDIA agent by signing the installed HyRoT with the certificate of either the BMC 134 or HyRoT. Preferably, both rows 1 and 2 are performed in the factory where the IHS 100 is constructed or assembled. Later on at rows 3 and 4 502c-d, the control plane may verify the trust in the SWIDIA agent by signing ensuing updated HyRoTs with the certificate of their previously installed HyRoTs. Thus as can be seen, a chain of trust may be established to a currently installed HyRoT that extends all the way back to the factory HSM 314.

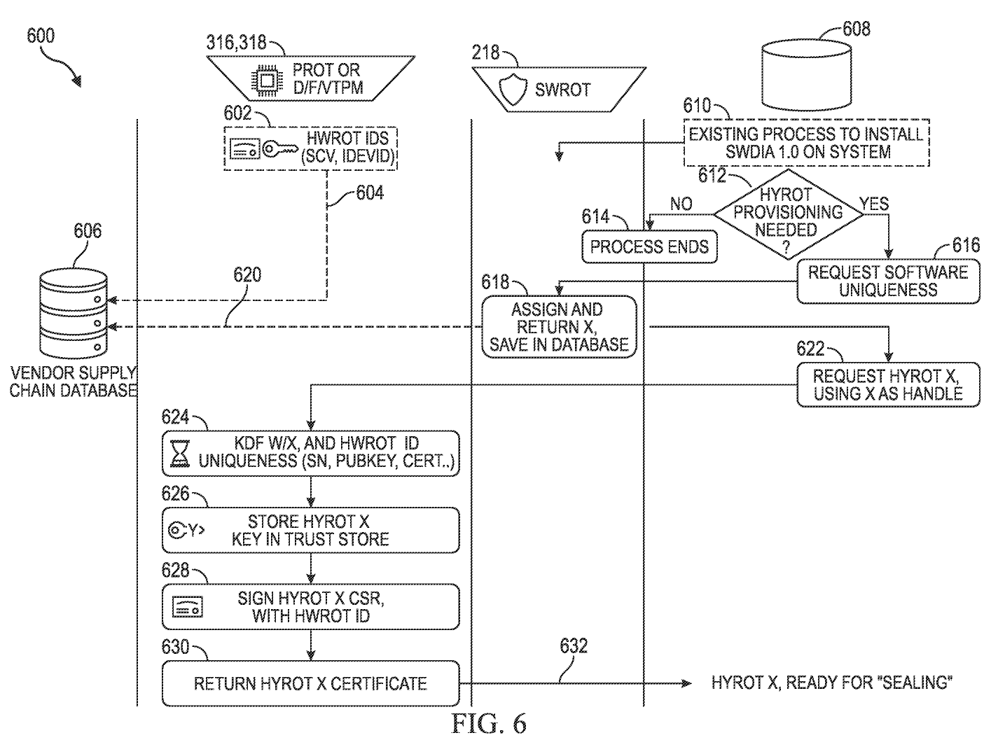

FIG. 6 illustrates an example software identity provisioning method 600 showing how the software identity and integrity securing system may be used to provision a SWIDIA identity with a SWIDIA agent 204 that has been installed on an IHS 100 according to one embodiment of the present disclosure. In one embodiment, the method 600 may be performed at the factory where the IHS 100 has been manufactured or otherwise assembled into its final form by the vendor of the IHS 100. Additionally or alternatively, the software identity provisioning method 600 may be performed by the trust hierarchy establishment method 300 as shown and described above with reference to FIG. 3.

Initially at step 602, the software identity provisioning method 600 installs HWRoT identities on the IHS 100. Examples of suitable components on which the HWRoT identities may be installed on may include, the BMC 134, an SCV component, a dTPM, a fTPM, or a vTPM. Thereafter at step 604, the HWRoT identities are sent to a vendor supply chain database 606. The software identity provisioning method 600 also obtains the initial version of the SWIDIA agent 204a from storage 608 and installs it on the IHS 100 at step 610. At step 612, the software identity provisioning method 600 determines whether the IHS 100 is to be configured with the HyRoT identity. If not, the process ends at step 614; otherwise processing continues at step 616 in which the software identity provisioning method 600 requests software unique serial number from the SWIDIA service 218. In response, the SWIDIA service 218 assigns and returns the requested serial number, and stores the serial number in its database at step 618. The SWIDIA service 218 also sends the assigned serial number to the vendor supply chain database 606 at step 620. The serial number may be assigned in any suitable manner. In one embodiment, the serial number may be a static ID Number, such as one that is assigned from the control plane. The serial number may be programmatically derived, such as from metadata from a remote command or via attestation (i.e. periodic reissuance). In yet another embodiment, the serial number may be derived from boot time measurements (e.g., TPM, PCR, software integrity, etc.). In yet another embodiment, the serial number may be derived based on the history of software updates over time.

At step 622, the SWIDIA service 218 provides the serial number to the SWIDIA agent 204a installed on the IHS 100. The SWIDIA agent 204a needs to obtain its identity, so at step 624, the RoT 316, 318 (e.g., BMC, TPM, etc.) performs a KDF with the serial number and hardware identity of the RoT 316,318 to create an identity for the SWIDIA agent 204a. The RoT 316,318 then stores the identity in a trust store at step 626, signs the identity with its HWRoT identity at 628, and sends the identity of the SWIDIA agent 204a to the SWIDIA agent 204a at step 630. At this point, the identity of the SWIDIA agent 204a is ready for sealing.

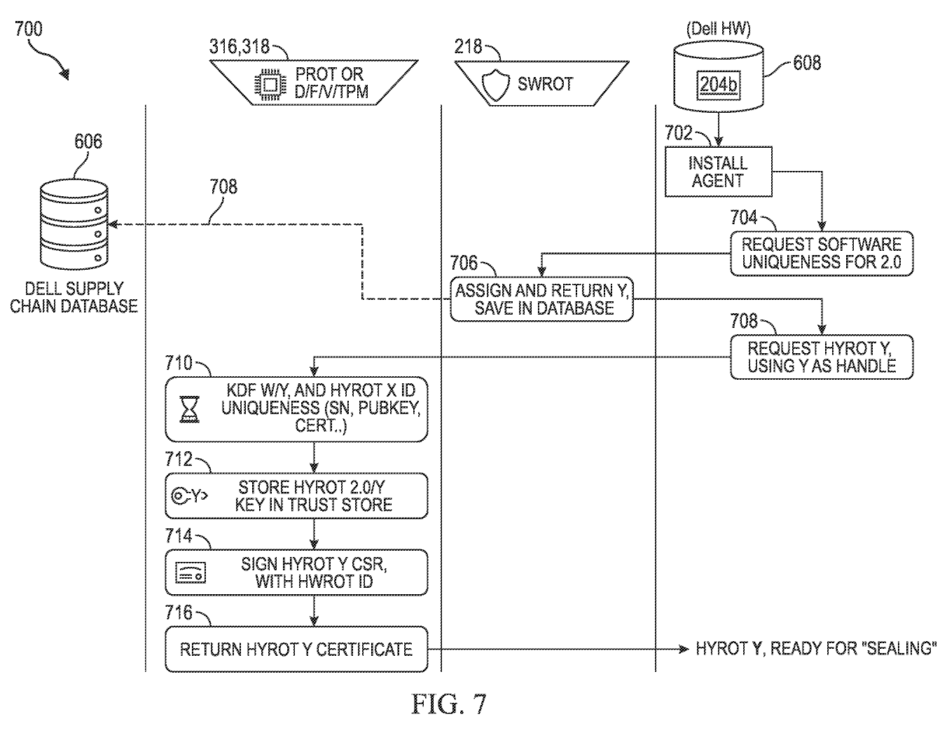

FIG. 7 illustrates an example software identity re-provisioning method 700 showing how the software identity and integrity securing system may be used to re-provision a SWIDIA identity with an updated SWIDIA agent according to one embodiment of the present disclosure. In one embodiment, the method 700 may be performed in the field after the SWIDIA agent 204a has been updated with a new SWIDIA agent 204b. Also, the software identity re-provisioning method 700 may be performed on an IHS 100 that was constructed or assembled by its vendor as well as an IHS 100 that was constructed or assembled by a third party separate and distinct from the manager of the trust hierarchy establishment method 300. Additionally or alternatively, the software identity re-provisioning method 700 may be performed by the trust hierarchy establishment method 300 as shown and described above with reference to FIG. 3.

At step 702, the software identity re-provisioning method 700 obtains an updated version of the SWIDIA agent 204b from storage 608 and installs it on the IHS 100. At step 704, the software identity re-provisioning method 700 requests a unique serial number from the SWIDIA service 218. In response, the SWIDIA service 218 assigns and returns the requested serial number, and stores the serial number in its database at step 706. The SWIDIA service 218 also sends the assigned serial number to the vendor supply chain database 606 at step 708. The serial number may be assigned in any suitable manner, such as described above with reference to step 618 of FIG. 6. At step 708, the SWIDIA service 218 provides the serial number to the SWIDIA agent 204b installed on the IHS 100. The SWIDIA agent 204b needs to obtain its identity, so at step 710, the RoT 316, 318 (e.g., BMC, TPM, etc.) performs a KDF with the serial number and hardware identity of the RoT 316,318 to create an identity for the SWIDIA agent 204b. The RoT 316,318 then stores the identity in a trust store at step 712, signs the identity with its HWRoT identity at 714, and sends the identity of the SWIDIA agent 204b to the SWIDIA agent 204b at step 716. At this point, the identity of the SWIDIA agent 204b is ready for sealing.

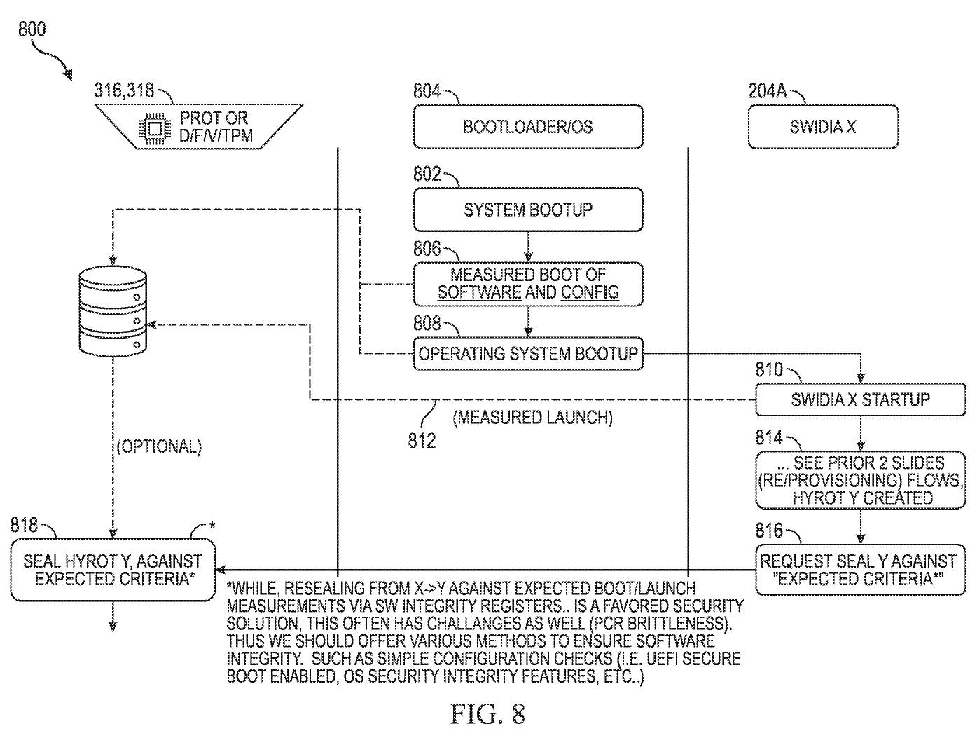

FIG. 8 illustrates an example software identity re-sealing method 800 showing how the software identity and integrity securing system may be used to re-seal a SWIDIA identity when the SWIDIA agent is updated with new firmware according to one embodiment of the present disclosure. For example, the method 800 may be performed in the field after the SWIDIA agent 204a has been updated with a new SWIDIA agent 204b. Additionally or alternatively, the software identity provisioning method 600 may be performed by the trust hierarchy establishment method 300 as shown and described above with reference to FIG. 3.

Initially at step 802, a bootloader commences a boot-up process of the IHS 100. At step 806, identity measurements of any software and configuration of the IHS 100 are performed. For example, the bootloader 804 may communicate with the HWRoT 316, 318 to measure any software configuration registers, such as PCRs, or those that conform to the DICE specification. Thereafter at step 808, the boot-up operation is completed.

Completion of the boot-up process causes the previous version of the SWIDIA agent 204a to be launched at step 810. During its launch, the SWIDIA agent 204a performs a measurement of its software to the HWRoT 316, 318 at step 812. For example, the SWIDIA agent 204a may generate a hash of its firmware and send it to the HWRoT 316, 318. At step 814, the Hybrid Root-of-Trust identity (e.g., HyRoT Y) associated with the new version of the SWIDIA agent 204b is created. For example, the software identity re-provisioning method 700 as described above with reference to FIG. 7 may be performed to generate the new identity. At step 816, the SWIDIA agent 204a requests to seal the newly generated identity (e.g., HyRoT Y) with the HWRoT 316, 318. The SWIDIA agent 204a can access the identity key of the HWRoT 316, 318 because it is in a trusted state by being previously authenticated at step 812. At step 818, the HWRoT 316, 318 seals the new identity associated with the new SWIDIA agent 204b against expected criteria (e.g. verify that the dual hashes match). Sealing generally refers to a condition in which only that instance (version) of agent 204 can use or have access to the identity key. For example, if malware were to be introduced into agent 204, the key mis-match would be detected, and thus the key would not be released to the agent 204.

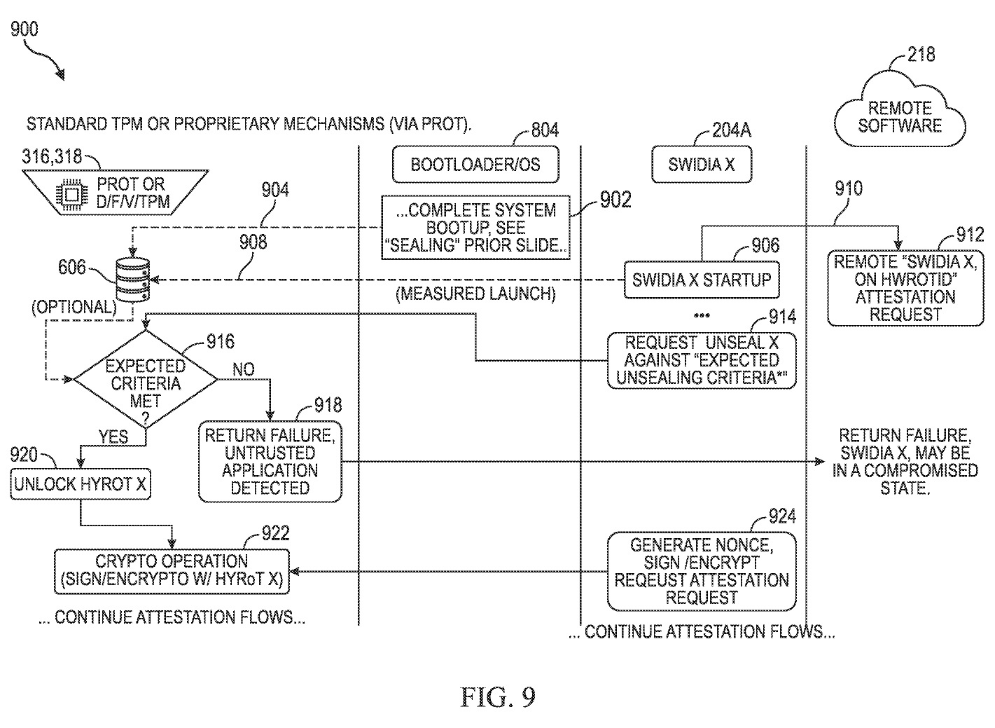

FIG. 9 illustrates an example software identity usage method 900 showing how the software identity and integrity securing system may be used in a trusted state according to one embodiment of the present disclosure. Additionally or alternatively, the software identity provisioning method 600 may be performed by the trust hierarchy establishment method 300 as shown and described above with reference to FIG. 3.

Initially at step 902, the bootloader 804 performs a system boot-up. During system boot-up, the bootloader 804 by attesting various system parameters with the HWRoT 316, 318 at step 904. Completion of the boot-up process causes the SWIDIA agent 204 to be launched at step 906. During its launch, the SWIDIA agent 204a performs a measurement of its software to the HWRoT 316, 318 at step 908. Additionally, during its launch, the SWIDIA agent 204a, at step 910, communicates with the SWIDIA service 218 to let it know that the SWIDIA agent 204a is being launched. In response, the SWIDIA service 218 issues an identity on HWRoT attestation request to the SWIDIA agent 204a at step 912. The SWIDIA agent 204a responds by issuing a request unseal the identity against expected unsealing criteria (e.g., cryptographic hash match) to the HWRoT 316, 318 at step 914.

The HWRoT 316, 318 determines whether the expected criteria are met at step 916. If the expected criteria are not met, the HWRoT 316, 318, at step 918, returns a failure message to the SWIDIA service 218 indicating that an untrusted application has been detected. Otherwise, the HWRoT 316, 318 unlocks the identity at step 920, and at step 922, performs a cryptographic operation to sign and encrypt the identity. The HWRoT 316, 318 then sends the encrypted and signed identity to the SWIDIA agent 204a at step 922. At this point, the SWIDIA agent 204a is considered to be in a trusted state. As such, using the encrypted and signed identity, the SWIDIA agent 204a may perform attestation with each of one or more applications running on the IHS 100, such as generating a nonce, signing and encrypting requests, and/or performing attestation requests at step 924.

Step 924 may be repeatedly performed to ensure the integrity and identity of other applications on the IHS 100. Nevertheless, when use of the software identity usage method 900 is no longer needed or desired, the process ends.

Although FIGS. 6 through 9 describe how the software identity and integrity securing system may be used for software identity issuance, the features of the process may be embodied in other specific forms without deviating from the spirit and scope of the present disclosure. For example, the process may perform additional, fewer, or different operations than those described in the present examples. For another example, the process may be performed in a sequence of steps different from that described above. For yet another example, the process may be performed by components other than what is described herein above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor;
a hardware device configured to function as a Hardware Root-of-Trust (HWRoT);
a Software Identity Framework agent stored in a memory coupled to a processor, the agent having program instructions that, upon execution by the processor, cause the Software Identity Framework agent to:
communicate with the hardware device to establish a trust chain with the HWRoT; and
using the trust chain, attest one or more applications configured on the IHS.

2. The IHS of claim 1, wherein the Software Identity Framework agent comprises a software identity issuing agent.

3. The IHS of claim 1, wherein the program instructions, upon execution by the host processor, further cause the Software Identity Framework agent to attest the cryptographic identity of the agent using a key derivation function.

4. The IHS of claim 3, wherein the program instructions, upon execution by the host processor, further cause the Software Identity Framework agent to generate an identity key using a HWRoT certificate associated with the HWRoT and a Software Identity Framework agent key associated with the Software Identity Framework agent.

5. The IHS of claim 4, wherein the program instructions, upon execution by the host processor, further cause the Software Identity Framework agent to generate the identity key in a factory where the IHS is assembled.

6. The IHS of claim 4, wherein the program instructions, upon execution by the host processor, further cause the Software Identity Framework agent to attest the identity key using a Software Identity Issuance Agent (SWIDIA) service.

7. The IHS of claim 1, wherein the program instructions, upon execution by the host processor, further cause the Software Identity Framework agent to, when the Software Identity Framework agent is updated, generate another identity key using the identity key from the previous version of the Software Identity Framework agent.

8. The IHS of claim 1, wherein the hardware device comprises a silicon-based unique serial number, a trusted platform module (TPM), an overall platform Root of Trust, a CPU Root of Trust, or a Baseboard Management Controller (BMC) configured in the IHS.

9. A software identity and integrity securing method comprising:
communicating, using a Software Identity Framework agent, with a hardware device to establish a trust chain with a Hardware Root-of-Trust (HWRoT), wherein a hardware device is configured to function as the HWRoT; and
using the trust chain, attest one or more applications configured on an Information Handling System (HIS).

10. The software identity and integrity securing method of claim 9, further comprising attesting the cryptographic identity of the agent using a key derivation function.

11. The software identity and integrity securing method of claim 10, further comprising generating an identity key using a HWRoT certificate associated with the HWRoT and a Software Identity Framework agent key associated with the Software Identity Framework agent.

12. The software identity and integrity securing method of claim 10, further comprising generating the identity key in a factory where the IHS is assembled.

13. The software identity and integrity securing method of claim 10, further comprising attesting the identity key using a SWIDIA service.

14. The software identity and integrity securing method of claim 10, further comprising, when the Software Identity Framework agent is updated, generating another identity key using the identity key from the previous version of the Software Identity Framework agent.

15. A non-transitory memory storage device having program instructions stored thereon that, upon execution by an Information Handling System (IHS), cause the IHS to:
communicate, using a Software Identity Framework agent, with the hardware device to establish a trust chain with a Hardware Root-of-Trust (HWRoT), wherein a hardware device is configured to function as the HWRoT; and
using the trust chain, attest one or more applications configured on the IHS.

16. The non-transitory memory storage device of claim 15, wherein the program instructions, upon execution by the host processor, further cause the Software Identity Framework agent to attest the Software Identity Framework agent using a key derivation function.

17. The non-transitory memory storage device of claim 16, wherein the program instructions, upon execution by the host processor, further cause the Software Identity Framework agent to generate an identity key using a HWRoT certificate associated with the HWRoT and a Software Identity Framework agent key associated with the Software Identity Framework agent.

18. The non-transitory memory storage device of claim 17, wherein the program instructions, upon execution by the host processor, further cause the Software Identity Framework agent to generate the identity key in a factory where the IHS is assembled.

19. The non-transitory memory storage device of claim 15, wherein the program instructions, upon execution by the host processor, further cause the Software Identity Framework agent to, when the Software Identity Framework agent is updated, generate another identity key using the identity key from the previous version of the Software Identity Framework agent.

20. The non-transitory memory storage device of claim 15, wherein the hardware device comprises a silicon-based unique serial number, a trusted platform module (TPM), an overall platform Root of Trust, a CPU Root of Trust, or a Baseboard Management Controller (BMC) configured in the IHS.
